(19) United States
(12) Patent Application Publication
(10) Pub. No.: US 2006/0263044 A1
(43) Pub. Date: Nov. 23, 2006

(54) Method of providing time shift function in audio/video network and apparatus for the same

(75) Inventors: Hyun-woo Kim, Incheon Metropolitan City (KR); Tae-yun An, Yongin-si (KR); Byung-hee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/417,237

(22) Filed: May 4, 2006

(30) Foreign Application Priority Data
May 18, 2005 (KR) 10-2005-0041678

(51) Int. Cl. H04N 5/91

(52) U.S. Cl. 386/83; 386/86

(57) ABSTRACT

A method and apparatus of providing a time shift function in an audio/video (A/V) network are provided. The method of providing the time shift function includes restoring broadcast content of received broadcast signals; transmitting the restored broadcast content to a content output apparatus; transmitting the restored broadcast content to a content storage apparatus; and interrupting the transmission of the broadcast content to the content output apparatus if the time shift function is requested.

### CROSS-REFERENCE TO RELATED APPLICATION

This application claims priority from Korean Patent Application No. 10-2005-0041678 filed on May 18, 2005 in the Korean Intellectual Property Office, the disclosure of which is incorporated herein by reference in its entirety.

### BACKGROUND OF THE INVENTION

1. Field of the Invention

Methods and apparatuses consistent with the present invention relate to a time shift function and, more particularly, to providing a time shift function for decreasing latency time caused by channel switching in an audio/video (A/V) network having a separate content storage apparatus.

2. Description of the Related Art

Recently, with the advancements in broadcasting technologies, implementation of digital broadcasting through satellite broadcasting, terrestrial broadcasting and cable broadcasting is gradually increasing. In order to receive digital broadcasts provided by a broadcast service provider, a digital-broadcast receiving apparatus such as a set-top box or a digital television (TV) capable of demodulating digital information is required at the user's side. In digital broadcasting, video and audio streams are compressed into packets of digital information prior to being transmitted. The digital-broadcast receiving apparatus then decompresses the digitized packets of video and audio information and outputs them to a display device.

Recent set-top boxes and digital TVs which have been developed to receive and output digital broadcasts, also provide various functions unavailable in conventional analog TVs.

For example, digital broadcast commonly includes an electronic program guide (EPG) which provides information about broadcast programs, in addition to video and audio information. Thus, viewers can readily obtain information about broadcast programs according to day, channel and time.

Further, the digital-broadcast receiving apparatuses have a time shift function which can enable the apparatuses to extract a specific bit stream from the broadcast streams, store it in memory provided in the set-top box or the digital TV to be played at the request of a user. The time shift function allows viewers to record broadcast content while away and watch it later at their convenience.

Recently, rather than having an embedded memory in the digital-broadcast receiving apparatus, an A/V system having a content storage apparatus separated from the digital-broadcast receiving apparatus has been developed. In this case, broadcast content is stored in the content storage apparatus rather than in the digital-broadcast receiving apparatus. The stored broadcast content is then transmitted from the content storage apparatus to a display device (e.g., TV) to be viewed by a user.

Here, when the user switches channels, the TV directs the digital-broadcast receiving apparatus to switch to a new channel, and the digital-broadcast receiving apparatus extracts broadcast content from the broadcast signals of the switched channel and transmits it to the content storage apparatus in response to the direction of the TV. Thereafter, the content storage apparatus stores the broadcast content transmitted from the digital-broadcasting receiving apparatus and again transmits the stored broadcast content to the TV. As a result, in an A/V network environment in which a separate content storage apparatus is used to provide a time shift function, there is an inconvenience in that a viewer must wait for channel switching for a predetermined time after the viewer has switched channel using a remote controller. Therefore, decreasing the latency time caused by channel switching, when a separate content storage apparatus is used to provide a time shift function in an A/V network, is desired.

Korean Unexamined Patent Publication No. 2002-78339, entitled “Transport Demultiplexer Having Time Shift Function”, discloses a technology for overcoming the problem of having a separate personal video recorder (PVR) for supporting a time shift function between a channel terminal and a transport unit by implementing the time shift function within the transport unit using a small logic device. However, Korean Unexamined Patent Publication No. 2002-78339 does not disclose a technology for decreasing the latency time caused by channel switching, generated at the time of channel switching, in an A/V network environment having a separate content storage apparatus to provide a time shift function.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a method and apparatus which may decrease latency time caused by channel switching, which is generated when a separate content storage apparatus is used to provide a time shift function.

According to an aspect of the present invention, there is provided a method of providing a time shift function according to an exemplary embodiment of the present invention includes restoring broadcast content of received broadcast signals; transmitting the restored broadcast content to a content output apparatus; transmitting the restored broadcast content to a content storage apparatus; and interrupting the transmission of the broadcast content to the content output apparatus when the time shift function is requested.

According to an aspect of the present invention, there is provided a method of providing a time shift function, including receiving broadcast content from a broadcast receiving apparatus; storing the received broadcast content; and transmitting the stored broadcast content to a content output apparatus when the time shift function is requested.

According to an aspect of the present invention, there is provided a broadcast receiving apparatus including a restoration module for restoring broadcast content of received broadcast signals; a device interface module for transmitting the restored broadcast content to a content output apparatus and a content storage apparatus; and a control module for interrupting the transmission of the broadcast content to the content output apparatus when a time shift function is requested.

According to an aspect of the present invention, there is provided a content output apparatus including a control module for determining one of a broadcast receiving apparatus and a content storage apparatus that will receive broadcast content, depending on whether a time shift function is requested; a device interface module for receiving the broadcast content from the broadcast receiving apparatus or the content storage apparatus based on the determination of the control module; and a content output module for outputting the received broadcast content to a display device.

According to an aspect of the present invention, there is provided a content storage apparatus including a device interface module for receiving broadcast content from a broadcast receiving apparatus; a storage module for storing the received broadcast content; and a control module for transmitting the stored broadcast content to a content output apparatus through the device interface module when a time shift function is requested.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a diagram illustrating an A/V system according to an exemplary embodiment of the present invention;

FIG. 2 is a diagram illustrating a broadcast receiving apparatus according to an exemplary embodiment of the present invention;

FIG. 3 is a block diagram illustrating a content output apparatus according to an exemplary embodiment of the present invention;

FIG. 4 is a block diagram illustrating a content storage apparatus according to an exemplary embodiment of the present invention;

FIG. 5 is a flowchart illustrating the operation of the A/V system according to an exemplary embodiment of the present invention;

FIG. 6 is a flowchart illustrating a process in which a broadcast receiving apparatus transmits broadcast content to a content storage apparatus;

FIG. 7 is a diagram illustrating a method of providing a time shift function according to an exemplary embodiment of the present invention; and

FIG. 8 is a flowchart illustrating the operation of a content storage apparatus when a time shift function has been cancelled, according to an exemplary embodiment of the present invention.

### DESCRIPTION OF THE EXEMPLARY EMBODIMENTS

Reference now will be made to the drawings, in which the same reference numerals are used throughout the different drawings to designate the same or similar components.

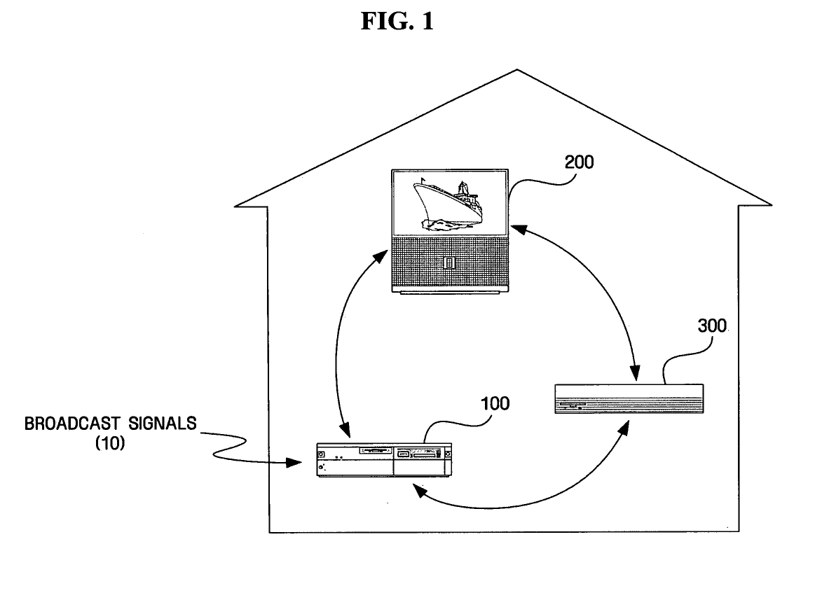

FIG. 1 is a diagram illustrating an A/V system according to an exemplary embodiment of the present invention.

The A/V system illustrated in FIG. 1 includes a broadcast receiving apparatus 100, a content output apparatus 200 and a content storage apparatus 300.

The broadcast receiving apparatus 100 receives broadcast signals 10 transmitted from a broadcast service provider, and restores broadcast content of the received broadcast signals. The broadcast content includes a variety of broadcast programs such as movies, soap operas, or news.

The broadcast receiving apparatus 100 transmits the restored broadcast content to the content output apparatus 200 and the content storage apparatus 300. In this case, the transmission of the broadcast content to the content storage apparatus 300 can be performed when a user does not switch channel after a predetermined time. Further, when the user activates a time shift function, the broadcast receiving apparatus 100 can interrupt the transmission of the broadcast content to the content output apparatus 200. The broadcast receiving apparatus 100 may be implemented using a set-top box or a network interface unit (NIT).

In the descriptions of the present invention, the time shift function refers to a function in which the broadcast receiving apparatus 100 stores the broadcast content included in the received broadcast signals in the content storage apparatus 300, and the content output apparatus 200 provides the broadcast content stored in the content storage apparatus 300 to a display device (not shown) when requested by a user. Therefore, the broadcast content, which is provided to the display device according to the time shift function, is delayed in time with respect to the broadcast content included in the broadcast signals currently received by the broadcast receiving apparatus 100. The time shift function includes detailed functions, such as a pause function, a reverse-play function and a fast-forward function for current broadcast content, and a play function for previously viewed broadcast content.

The content output apparatus 200 outputs the broadcast content, transmitted from the broadcast receiving apparatus 100 or the content storage apparatus 300. For this, the content output apparatus 200 may include a speaker module (not shown) for outputting audio signals and a display module (not shown) for outputting video signals. The content output apparatus 200 may be implemented using a digital TV, a projector, or a monitor.

The content storage apparatus 300 refers to a kind of A/V hard disk drive (HDD) and stores broadcast content transmitted from the broadcast receiving apparatus 100. When the user requests the time shift function, the content storage apparatus 300 transmits the stored broadcast content to the content output apparatus 200.

According to an exemplary embodiment of the present invention, the broadcast receiving apparatus 100 and the content storage apparatus 300 may be connected to the content output apparatus 200 in a daisy chain fashion around the content output apparatus 200. As a result, when the user requests channel switching or the time shift function, the content output apparatus 200 can direct the broadcast receiving apparatus 100 and the content storage apparatus 300 to perform tasks required for the channel switching or the time shift function.

Meanwhile, at the time of the transmission of data between the broadcast receiving apparatus 100, the content output apparatus 200 and the content storage apparatus 300, a predetermined protocol, such as a high-bandwidth digital content protection (HDCP) protocol or a digital transmission content protection (DTCP) protocol, may be used.

According to an exemplary embodiment of the present invention, the A/V network illustrated in FIG. 1 may be implemented using an expandable home theater (XHT) technology that acts as middleware for A/V home networking.

The XHT technology is a home network solution using a digital TV, developed by Samsung Electronics Co., Ltd., was adopted as a standard by the Consumer Electronics Association (CEA).

The XHT technology allows users to control not only A/V devices connected to the digital TV but also several digital TVs using a communication standard, that is, an Internet protocol, which is mainly used in IEEE 1394 cables for stably transmitting high definition (HD) class signals and the Internet. When using the XHT technology, the user in one room can view digital broadcast utilizing the digital broadcast reception function of a digital TV located in another room.

The broadcast receiving apparatus 100, the content output apparatus 200 and the content storage apparatus 300, which constitute the above-described A/V system, are described below in detail.

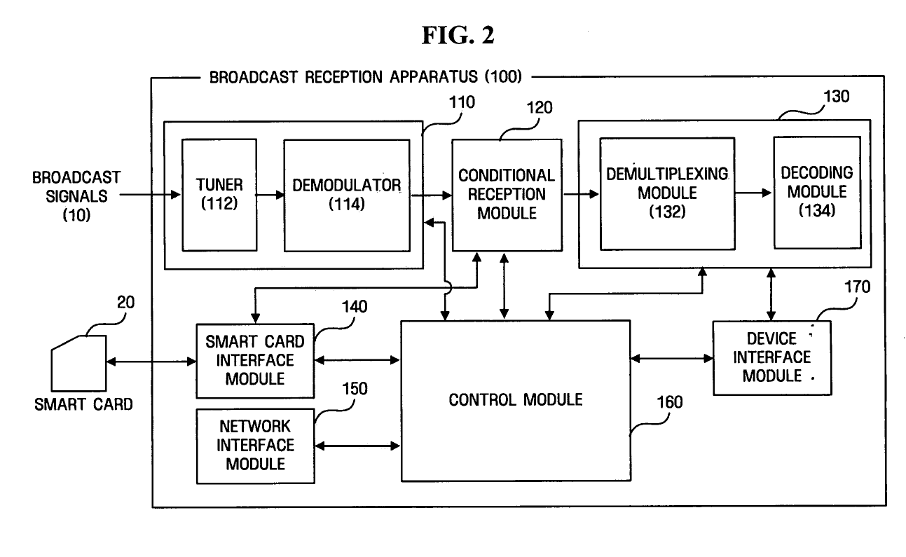

FIG. 2 is a diagram illustrating a broadcast receiving apparatus according to an exemplary embodiment of the present invention.

The illustrated broadcast receiving apparatus 100 includes a broadcasting reception module 110, a conditional reception module 120, a restoration module 130, a smart card interface module 140, a network interface module 150, a control module 160 and a device interface module 170.

The broadcasting reception module 110 functions to receive broadcast signals, and includes a tuner 112 and a demodulator 114.

The tuner 112 receives the broadcast signals of a channel selected by a user using a channel tuning operation, converts the received broadcast signals into intermediate frequencies, and outputs them to the demodulator 114. For example, when the broadcast receiving apparatus 100 illustrated in FIG. 2 receives a satellite broadcast, the tuner 112 detects I and Q signals by processing the signals received from a satellite, and outputs the detected I and Q signals to the demodulator 114.

The demodulator 114 restores transport streams from the signals, which have been converted into the intermediate frequencies, and outputs the restored transport streams to the conditional reception module 120. For example, the demodulator 114 may be composed of a quadratic phase shift keying QPSK demodulator (not shown) and a forward error correction (FEC) demodulator (not shown), and can perform QPSK demodulation or FEC operations.

The conditional reception module 120 performs a user authentication operation using the smart card 20. More particularly, the conditional reception module 120 compares an authentication parameter, which is included in the transport streams provided from the demodulator 114, with another authentication parameter, which is provided by the smart card interface module 140 through the reading of the smart card 20, and determines whether the user of the broadcast receiving apparatus 100 has the right to receive a broadcast. If the two authentication parameters are identical to each other, it can be determined that the user has the right to receive the broadcast. If not, it can be determined that the user does not have the right.

If, as a result of the user authentication, it is determined that the user have the right to receive the broadcast, the conditional reception module 120 descrambles the transport streams. However, if, as a result of the user authentication, it is determined that the user does not have the right the conditional reception module 120 does not descramble the transport streams. As a result, the descrambling operation is performed on the broadcast signals of a channel for which the user has paid for subscription, whereas the descrambling operation is not performed on the broadcast signals of a channel for which the user has not paid.

The restoration module 130 restores the broadcast content using the transport streams descrambled by the conditional reception module 120. However, when the conditional reception module 120 does not descramble the transport streams, the restoration module 130 cannot normally restore the broadcast content included in the transport streams.

In order to restore the broadcast content, the restoration module 130 includes a demultiplexing module 132 and a decoding module 134.

The demultiplexing module 132 separates audio signals and video signals by parsing the transport streams descrambled by the conditional reception module 120, and outputs them to the decoding module 134.

The decoding module 134 includes a video decoder (not shown) and an audio decoder (not shown). The video and audio decoders respectively decode the video signals and audio signals provided from the demultiplexing module 132. The video decoder can be implemented using a video decompression method such as Moving Picture Experts Group (MPEG)-2 or MPEG-4. The audio decoder can be implemented using an audio decompression method such as MPEG Layer-3 Audio (MP3) or Audio Compression 3 (AC3).

The smart card interface module 140 reads a user's smart card 20 and outputs an authentication parameter stored in the smart card 20 to the conditional reception module 120. According to another exemplary embodiment of the present invention, another type of portable storage medium that can store an authentication parameter, such as an SD card or a memory stick, may be used in place of the smart card 20. In this case, the smart card interface module 140 may be replaced with an interface module that can be connected to a corresponding portable storage medium.

The network interface module 150 supports Internet Protocol-based communication, and connects to the broadcast provider 100. The broadcast receiving apparatus 100 can provide services interactive with the broadcast provider 100 to the user through the network interface module 150.

The control module 160 controls the operations of the modules, which constitute the broadcast receiving apparatus 100.

When channel switching is activated by the content output apparatus 200, the control module 160 controls the broadcast signal reception module 110 so as to receive the broadcast signals of a requested channel. Furthermore, when the time shift function is activated by the content output apparatus 200, the control module 160 interrupts the transmission of the broadcast content to the content output apparatus 200. At this time, the control module 160 can request the broadcast content to be provided the content output apparatus 200 from the content storage apparatus 300 through the device interface module 170. For the request, the control module 160 can generate a predetermined command.

Meanwhile, the control module 160 performs the tasks of establishing and disconnecting an A/V network connection with the content output apparatus 200 and the content storage apparatus 300 through the device interface module 170.

The device interface module 170 communicates with the content output apparatus 200 and the content storage apparatus 300 via a wired or wireless medium.

More particularly, the device interface module 170 transmits the broadcast content to the content output apparatus 200 and the content storage apparatus 300. Furthermore, the device interface module 170 transmits and receives commands to and from the content output apparatus 200 and the content storage apparatus 300. However, this is merely exemplary, and the broadcast receiving apparatus 100 according another exemplary embodiment of the present invention further includes a separate interface module for transmitting and receiving commands to and from the content output apparatus 200 and the content storage apparatus 300.

The device interface module 170 may use a security protocol, such as a high-bandwidth digital content protection (HDCP) or a digital transmission content protection (DTCP) protocol, in order to prevent the unauthorized copying of the broadcast content at the time of communicating with the content output apparatus 200 and the content storage apparatus 300.

Meanwhile, the device interface module 170 may provide a plurality of communication ports for connection with the content output apparatus 200 and the content storage apparatus 300.

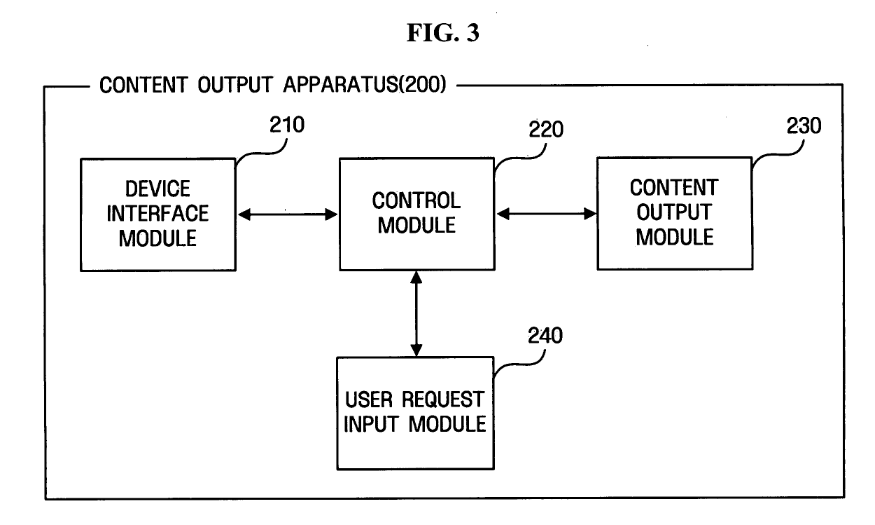

FIG. 3 is a block diagram illustrating the content output apparatus 200 according to an exemplary embodiment of the present invention.

The content output apparatus 200 illustrated in FIG. 3 includes a device interface module 210, a control module 220, a content output module 230 and a user request input module 240.

The device interface module 210 communicates with the broadcast receiving apparatus 100 and the content storage apparatus 300 via a wired or wireless medium.

More particularly, the device interface module 210 receives broadcast content from the broadcast receiving apparatus 100 and the content storage apparatus 300. Furthermore, the device interface module 210 transmits and receives commands to and from the broadcast receiving apparatus 100 and the content storage apparatus 300. However, this is merely exemplary, and the device interface module 210 according another exemplary embodiment of the present invention further includes a separate interface module for transmitting and receiving commands to and from the broadcast receiving apparatus 100 and the content storage apparatus 300.

The device interface module 210 may use a security protocol, such as an HDCP or DTCP protocol, in order to prevent the unauthorized copying of the broadcast content at the time of communicating with the broadcast receiving apparatus 100 and the content storage apparatus 300.

Meanwhile, the device interface module 210 may provide a plurality of communication ports for connection with the broadcast receiving apparatus 100 and the content storage apparatus 300.

The control module 220 controls the operations of functional blocks, which constitute the content output apparatus 200.

When channel switching is activated by the user request input module 240, the control module 220 performs channel switching from the broadcast receiving apparatus 100 through the device interface module 210. Furthermore, when the time shift function is activated by the device interface module 210, the control module 230 performs the time shift function from the broadcast receiving apparatus 100 through the device interface module 210. Here, the control module 220 may generate a predetermined command.

Meanwhile, the control module 220 performs the tasks of establishing and disconnecting an A/V network connection with the broadcast receiving apparatus 100 and the content storage apparatus 300.

The content output module 230 outputs the broadcast content received by the device interface module 210 to the user. For this, the content output module 230 may include a speaker module (not shown) and a display module (not shown). The speaker module outputs audio signals which constitute the broadcast audio content, and the display module outputs video signals which constitute the broadcast video content.

The user request input module 240 receives control commands from the user. For example, the user request input module 240 may receive a channel switching request, a time shift request or the like from the user.

For this, the user request input module 240 may provide an input means, such as a keypad, a touch screen or the like. Furthermore, the user request input module 240 may provide a wireless interface module, which can receive control signals through a wireless medium, such as an infrared (IR) receiver or a Bluetooth module. As a result, the user can input desired control signals through a remote controller or a home server.

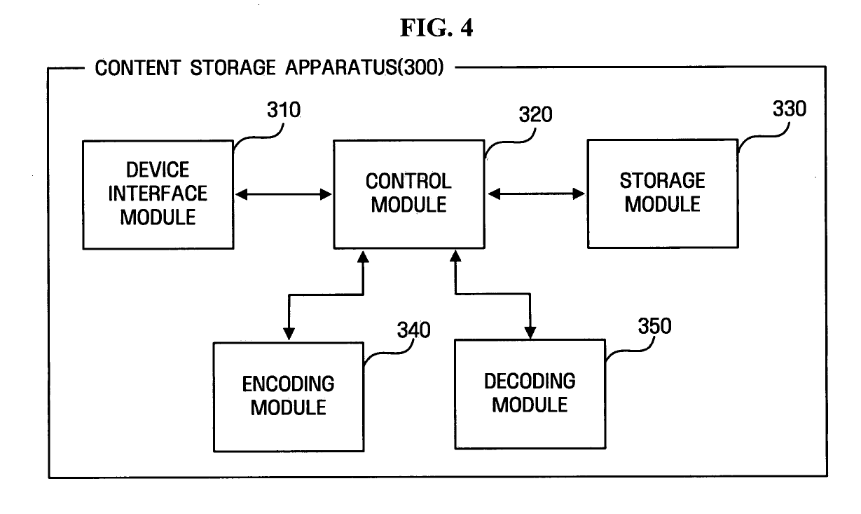

FIG. 4 is a block diagram illustrating the content storage apparatus 300 according to an exemplary embodiment of the present invention.

The content storage apparatus 300 illustrated in FIG. 4 includes a device interface module 310, a control module 320, a storage module 330, an encoding module 340 and a decoding module.

The device interface module 310 communicates with the broadcast receiving apparatus 100 and the content output apparatus 200 via a wired or wireless medium.

More particularly, the device interface module 310 receives broadcast content from the broadcast receiving apparatus 100 and transmits the broadcast content to the content output apparatus 200. Furthermore, the device interface module 310 transmits and receives commands to and from the broadcast receiving apparatus 100 and the content output apparatus 200. However, this is merely exemplary, and the content storage apparatus 300 according another exemplary embodiment of the present invention may further include a separate interface module for transmitting and receiving commands to and from the broadcast receiving apparatus 100 and the content output apparatus 200.

The device interface 310 may use a security protocol, such as an HDCP or DTCP protocol, in order to prevent the unauthorized copying of the broadcast content at the time of communicating with the broadcast receiving apparatus 100 and the content output apparatus 200.

Meanwhile, the device interface module 310 may provide a plurality of communication ports for connection with the broadcast receiving apparatus 100 and the content output apparatus 200.

The control module 320 controls the operations of functional blocks, which constitute the content storage apparatus 300.

When the time shift function is activated by the broadcast receiving apparatus 100 or the content output apparatus 200, the control module 320 controls the decoding module 350 so as to decode the broadcast content stored in the storage module 330. Thereafter, the control module 320 transmits the broadcast content decoded by the decoding module 350 to the content output apparatus 200 via the device interface module 310.

Furthermore, when receiving the channel switching request from the broadcast receiving apparatus 100 or the content output apparatus 200, the control module 230 interrupts the transmission of the broadcast content to the content output apparatus 200.

Meanwhile, the control module 320 performs the tasks of establishing and disconnecting an A/V network connection with the broadcast receiving apparatus 100 or the content output apparatus 200 through the device interface module 310.

The storage module 330 stores the broadcast content transmitted from the broadcast receiving apparatus 100. The broadcast content stored in the storage module 330 is encoded by the encoding module 340 using an A/V data compression method, such as MPEG-2, MPEG-4, MP3 or AC3.

The decoding module 350 decodes the content stored in the storage module 330. The A/V data decoding method used by the decoding module 350 corresponds to the A/V data encoding method used by the encoding module 340.

In the exemplary embodiments of FIGS. 2 to 4, the term ‘module’ refers to a software component or a hardware component, such as a field programmable gate-array (FPGA) or an application-specific integrated circuit (ASIC), and performs a specific function. However, the module is not limited to a software or hardware. The module may be configured to exist in an addressable storage medium or to perform one or more processes. Therefore, for example, the module includes components, such as software components, object-oriented software components, class components, or task components, processes, functions, attributes, procedures, subroutines, the segments of program code, drivers, firmware, micro-code, a circuit, data, a database, data structures, tables, arrays, and variables. Functions provided by the components and the modules are integrated into a smaller number of components and modules, or are separated into additional components and modules.

The operation of the broadcast receiving apparatus 100, the content output apparatus 200 and the content storage apparatus 300 are described below in detail.

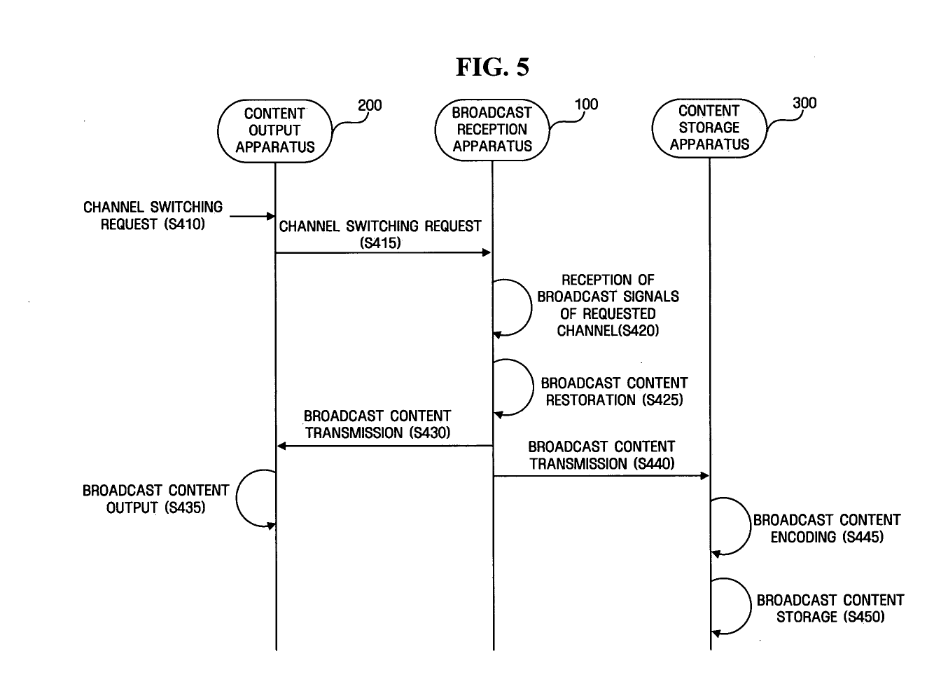

FIG. 5 is a flowchart illustrating the operation of the A/V system according to an exemplary embodiment of the present invention. The flowchart illustrated in FIG. 5 illustrates a predetermined process when the A/V system is not activated with a time shift function.

When a channel switching request is received through the user request input module 240 of the content output apparatus 200 at operation S410, the control module 220 performs channel switching from the broadcast receiving apparatus 100 via the device interface module 210 at operation S415. At this time, the control module 220 generates a command for the channel switching and transmits it to the broadcast receiving apparatus 100 via the device interface module 210.

When the device interface module 170 of the broadcast receiving apparatus 100 receives the command for the channel switching from the content output apparatus 200, the broadcast signal reception module 110 performs a channel tuning operation to receive the broadcast signals of a requested channel at operation S420. Thereafter, the restoration module 130 restores broadcast content included in the broadcast signals received by the broadcast signal reception module 110 at operation 425. Then, the device interface module 170 of the broadcast receiving apparatus 100 transmits the restored broadcast content to the content output apparatus 200 at operation S430. Prior to transmitting the broadcast content, the control module 160 of the broadcast receiving apparatus 100 and the control module 220 of the content output apparatus 200 can perform the task of establishing an A/V network connection respectively through the device interface module 170 of the broadcast receiving apparatus 100 and the device interface module 210 of the content output apparatus 200.

When the device interface module 210 of the content output apparatus 200 receives the broadcast content from the broadcast receiving apparatus 100, the content output module 230 outputs it to a display device at operation S435.

Meanwhile, the control module 160 of the broadcast receiving apparatus 100 transmits the broadcast content restored by the restoration module 130 to the content storage apparatus 300 via the device interface module 170. Before the transmission of the broadcast content, the control module 160 of the broadcast receiving apparatus 100 and the control module 320 of the content storage apparatus 300 may perform the task of establishing an A/V network connection respectively through the device interface module 170 of the broadcast receiving apparatus 100 and the device interface module 310 of the content storage apparatus 300.

When the device interface module 310 of the content storage apparatus 300 receives the broadcast content from the broadcast receiving apparatus 100, the encoding module 340 encodes the received broadcast content using a predetermined A/V compression method at operation S445.

Thereafter, the storage module 330 stores the broadcast content encoded by the encoding module 340 at operation S450.

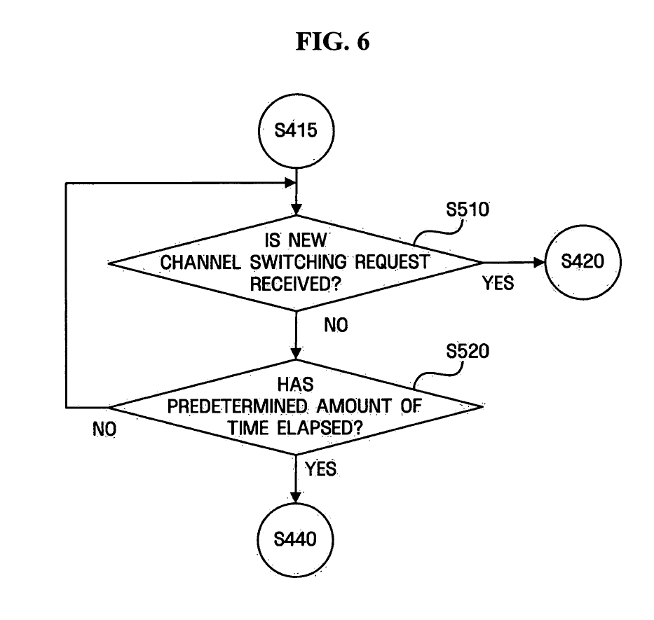

Meanwhile, operation S440, at which the broadcast receiving apparatus 100 transmits the broadcast content to the content storage apparatus 300, can be performed depending on a predetermined condition, which is described below with reference to FIG. 6.

When receiving the channel switching request from the content output apparatus 200 at operation S415, the control unit 160 of the broadcast receiving apparatus 100 determines whether a new channel switching request has been received from the content output apparatus 200 at operation S510. If it is determined that the device interface module 170 of the broadcast receiving apparatus 100 has received the new channel switching request from the content output apparatus 200, the control module 160 controls the functional blocks such that the broadcast receiving apparatus 100 performs operations S420 to S430 of FIG. 5.

However, if it is determined in operation S510 that the new channel switching request has not been received, the control module 160 of the broadcast receiving apparatus 100 determines whether a predetermined amount of time has elapsed from the reception time of a previous channel switching request at operation S520. If, it is determined that the new channel switching request has not been received after the predetermined time, the control module 160 transmits the broadcast content, which is restored by the restoration module 130, to the content storage module 300 via the device interface module 170. At this time, the predetermined time is set to the average time that has elapsed from the input of a previous channel switching request to the input of a new channel switching request when a user continuously switches channel using the channel switch buttons of a remote controller in order to browse channels. The predetermined time may be acquired, for example, through sample tests of many beta users.

As a result, the content storage apparatus 300 cannot store broadcast content while the user browses channels, but stores the broadcast content when it is determined that the user has actually selected a specific channel and is viewing the broadcast content of the channel.

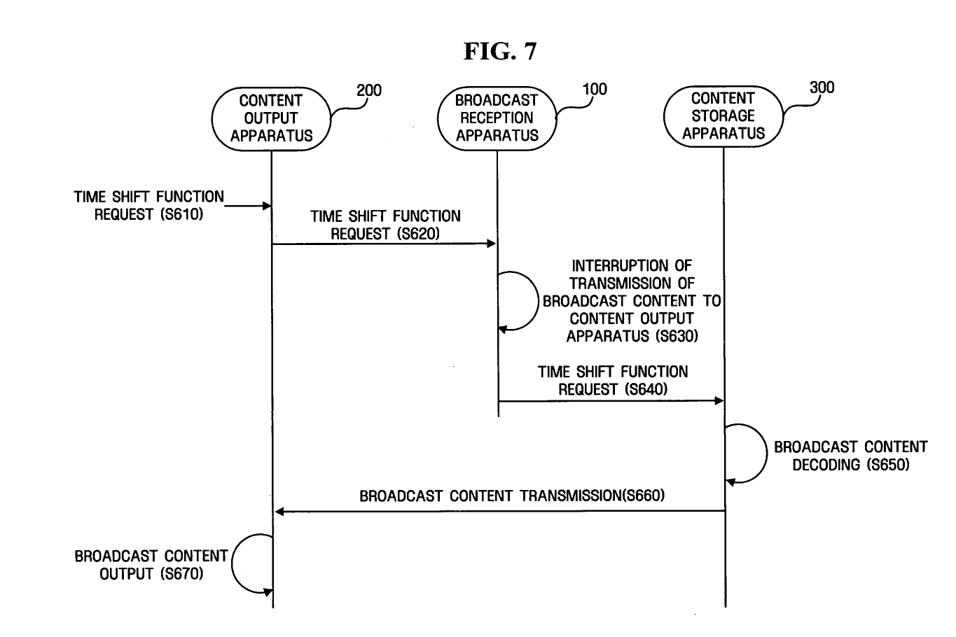

An exemplary embodiment in which a user activates the time shift function while the content storage apparatus 300 stores the broadcast content is described below with reference to FIG. 7.

FIG. 7 is a diagram illustrating a method of providing a time shift function according to an exemplary embodiment of the present invention.

When the time shift function is requested through the user request input module 220 of the content output apparatus 200 at operation S610, the control module 220 activate the time shift function from the broadcast receiving apparatus 100 via the device interface module 210 at operation S620. At this time, the control module 220 can generate a command for performing the time shift function and transmit it to the broadcast receiving apparatus 100 via the device interface module 210.

When the device interface module 170 of the broadcast receiving apparatus 100 receives the command for the time shift function, the control module 160 of the broadcast receiving apparatus 100 interrupts the transmission of the broadcast content to the content output apparatus 200 at operation S630. At this time, the control module 160 of the broadcast receiving apparatus 100 and the control module 220 of the content output apparatus 200 can perform the task of disconnecting the A/V network connection respectively through the device interface module 170 of the broadcast receiving apparatus 100 and the device interface module 210 of the content output apparatus 200.

Thereafter, the control module 160 of the broadcast receiving apparatus 100 activates the time shift function from the content storage apparatus 300 via the device interface module 170 at operation S640. At this time, the device interface module 170 can transmit the command for the time shift function, which is received from the content output apparatus 200 or generated by the control module 160, to the content storage apparatus 300.

When the device interface module of the content storage apparatus 300 receives the command for the time shift function from the broadcast receiving apparatus 100, the decoding module 350 decodes the broadcast content stored in the storage module 330 at operation S650.

Thereafter, the device interface module 310 of the content storage apparatus 300 transmits the decoded broadcast content to the content output apparatus 200 at operation S660. Before the transmission of the broadcast content, the control module 220 of the content output apparatus 200 and the control module 320 of the content storage apparatus 300 may perform the task of establishing an A/V network connection respectively through the device interface module 210 of the content output apparatus 200 and the device interface module 310 of the content storage apparatus 300.

When the device interface module 210 of the content output apparatus 200 receives the broadcast content from the content storage apparatus 300, the content output module 230 outputs the received broadcast content to the display device at operation S670.

According to another exemplary embodiment of the present invention, operation S640 of FIG. 7 may be replaced with the operation at which the control module 200 of the broadcasting output apparatus 200 directly activates the time shift function from the content storage apparatus 300 via the device interface module 210.

Meanwhile, of the operations illustrated in FIG. 7, operations S440 to S450, described with reference to FIG. 5, are continuously performed between the broadcast receiving apparatus 100 and content storage apparatus 300. That is, the device interface module of the content storage apparatus 300 continuously receives the broadcast content from the broadcast receiving apparatus 100, the encoding module 340 encodes the received broadcast content, and the storage module 330 stores the encoded broadcast content.

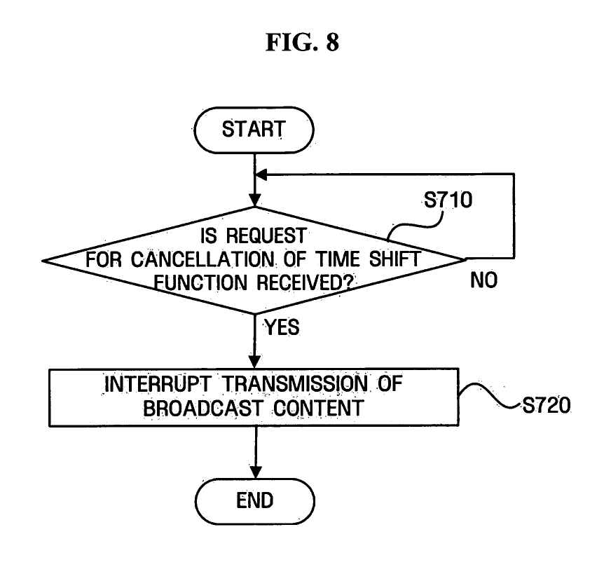

Furthermore, when the user performs channel switching during the performance of operations illustrated FIG. 7, the content output apparatus 200 activates the channel switching from the broadcast receiving apparatus 100, as at operation S415 of FIG. 5. Therefore, the control module 160 of the broadcast receiving apparatus 100 can cancel the time shift function from the content storage apparatus 300 via the device interface module 170. Alternatively, the control module 220 of the content output module 200 can directly cancel the time shift function from the content storage apparatus 300 via the device interface module 210. The operation of the content storage apparatus 300 at the time of cancellation of the time shift function is described with reference to FIG. 8

When the device interface module 310 of the content storage apparatus 300 receives a request for the cancellation of the time shift function from the broadcast receiving apparatus 100 or the content output apparatus 200 at operation S710, the control module 320 can interrupt the transmission of the broadcast content to the content output apparatus 200 at operation S720. At this time, the control module 320 of the content storage apparatus 300 and the control module 220 of the content output apparatus 200 can perform the task of releasing the A/V network connection respectively through the device interface module 310 of the content storage apparatus 300 and the device interface module 210 of the content output apparatus 200.

Meanwhile, according to another exemplary embodiment of the present invention, the channel switching, the time shift function and the time shift function cancellation, which are transmitted and received between the broadcast receiving apparatus 100, the content output apparatus 200 and the content storage apparatus 300 at the channel switching and time shift function activated the user, may be directly transmitted to each of the broadcast receiving apparatus 100, the content output apparatus 200 and the content storage apparatus 300 through a separate server (not shown) which controls the A/V system.

As described above, according to a method of providing a time shift function in the A/V network apparatus of the present invention and apparatuses for the same, the latency time caused by channel switching can be decreased.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a time shift function, the method comprising:
restoring broadcast content of received broadcast signals;
transmitting the restored broadcast content to a content output apparatus;
transmitting the restored broadcast content to a content storage apparatus; and
interrupting the transmission of the broadcast content to the content output apparatus if the time shift function is requested.

2. The method as claimed in claim 1, wherein the transmitting the restored broadcast content to the content storage apparatus is performed if channel switching is not requested within a predetermined time.

3. The method as claimed in claim 1, further comprising, if a channel switching request is received after the interrupting the transmission of the broadcast content:
restoring broadcast content of broadcast signals of a new channel according to the channel switching request; and
transmitting the restored broadcast content of the broadcast signals of the new channel to the content output apparatus.

4. The method as claimed in claim 3, wherein:
the interrupting the transmission of the broadcast content comprises disconnecting an audio/video (A/V) network connection with the content output apparatus; and
the transmitting the restored broadcast content of the broadcast signals of the new channel to the content output apparatus comprises establishing an A/V network connection with the content output apparatus.

5. A method of providing a time shift function, the method comprising:
outputting broadcast content received from a broadcast receiving apparatus; and
outputting broadcast content received from a content storage apparatus if the time shift function is requested.

6. The method as claimed in claim 5, wherein the outputting broadcast content received from a content storage apparatus comprises:
disconnecting an audio/video (A/V) network connection with the broadcast receiving apparatus;
establishing an A/V network connection with the content storage apparatus;
receiving the broadcast content from the content storage apparatus; and
outputting the broadcast content received from the content storage apparatus.

7. The method as claimed in claim 5, wherein the broadcast content received from the content storage apparatus is broadcast content which the content storage apparatus receives from the broadcast receiving apparatus and stores.

8. A method of providing a time shift function, the method comprising the:
receiving broadcast content from a broadcast receiving apparatus;
storing the received broadcast content; and
transmitting the stored broadcast content to a content output apparatus if the time shift function is requested.

9. The method as claimed in claim 8, wherein the receiving the broadcast content is performed if channel switching is not requested within a predetermined time.

10. The method as claimed in claim 8 further comprising the step of interrupting the transmission of the broadcast content to the content output apparatus if the channel switching is requested.

11. The method as claimed in claim 10, wherein:
the transmitting the stored broadcast content to the content output apparatus comprises establishing an audio/video (A/V) network connection with the content output apparatus; and
the interrupting the transmission of the broadcast content to the content output apparatus comprises disconnecting the A/V network connection with the content output apparatus.

12. A broadcast receiving apparatus comprising:
a restoration module which restores broadcast content of received broadcast signals;
a device interface module which transmits the restored broadcast content to a content output apparatus and a content storage apparatus; and
a control module which interrupts the transmission of the broadcast content to the content output apparatus by the device interface module if a time shift function is requested.

13. The broadcast receiving apparatus as claimed in claim 12, wherein the device interface module transmits the restored broadcast content to the content storage apparatus if a channel switching request has hot been received within a predetermined time.

14. The broadcast receiving apparatus as claimed in claim 12, wherein, if channel switching is requested after the control module has interrupted the transmission of the broadcast content to the content output apparatus:
the restoration module restores broadcast content of broadcast signals of a new channel according to the channel switching request; and
the device interface module transmits the restored broadcast content of the broadcast signals of the channel to the content output apparatus.

15. The broadcast receiving apparatus as claimed in claim 14, wherein the control module establishes or disconnects audio/video network connections between the device interface module, the content output apparatus, and the content storage apparatus.

16. A content output apparatus, comprising:
a control module which determines one of a broadcast receiving apparatus and a content storage apparatus that will receive broadcast content, depending on whether a time shift function is requested;
a device interface module which receives the broadcast content from the broadcast receiving apparatus or the content storage apparatus based on the determination of the control module; and
a content output module which outputs the received broadcast content to a display device.

17. The content output apparatus as claimed in claim 16, wherein the control module establishes or disconnects audio/video network connections between the device interface module, the content output apparatus, and the content storage apparatus according to the determined result.

18. The content output apparatus as claimed in claim 16, wherein the broadcast content received from the content storage apparatus is broadcast content which the content storage apparatus receives from the broadcast receiving apparatus and stores.

19. A content storage apparatus, comprising:
a device interface module which receives broadcast content from a broadcast receiving apparatus;
a storage module which stores the received broadcast content; and
a control module which transmits the stored broadcast content to a content output apparatus through the device interface module if a time shift function is requested.

20. The content storage apparatus as claimed in claim 19, wherein the device interface module receives the broadcast content from the broadcast receiving apparatus if channel switching is not requested within a predetermined time.

21. The content storage apparatus as claimed in claim 19, wherein the control module interrupts the transmission of the broadcast content to the content output apparatus if channel switching is requested.

22. The content storage apparatus as claimed in claim 21, wherein the control module establishes or disconnects audio/video network connections between the device interface module, the content output apparatus, and the content storage apparatus.
